(19) United States
(12) Patent Application Publication
(10) Pub. No.: US 2017/0097531 A1
(43) Pub. Date: Apr. 6, 2017

(54) LIQUID CRYSTAL DEVICE AND ELECTRONIC APPARATUS

(71) Applicant: SEIKO EPSON CORPORATION, Tokyo (JP)

(72) Inventor: Yoshitake TATENO, Chitose-shi (JP)

(73) Assignee: SEIKO EPSON CORPORATION, Tokyo (JP)

(21) Appl. No.: 15/193,986

(22) Filed: Jun. 27, 2016

(30) Foreign Application Priority Data
Oct. 5, 2015 (JP) 2015-197403

(51) Int. Cl. G02F 1/13363; G02F 1/1335

(52) U.S. Cl. CPC G02F 1/13363; G02F 1/133526; G02F 2413/02; G02F 2413/05; G02F 2413/08; G02F 2201/123

(57) ABSTRACT

A liquid crystal device includes a liquid crystal panel and an anti-dust translucent substrate fixed to a first surface of the liquid crystal panel. The translucent substrate includes a first phase difference compensation element having a first optical axis and integrally formed on a first surface of the translucent substrate, and a second phase difference compensation element having a second optical axis is opposed to the first phase difference compensation element. The second phase difference compensation element is placed such that an alignment direction of liquid crystal molecules of a liquid crystal layer is located in an angular position between the extending direction of the first optical axis and the extending direction of the second optical axis.

### BACKGROUND

1. Technical Field

The present invention relates to a liquid crystal device including a phase difference compensation element, and to an electronic apparatus.

2. Related Art

Among liquid crystal devices employed as light bulb of a projection display device, for example a liquid crystal device of VA mode is configured such that liquid crystal molecules are vertically aligned when a voltage is not applied to a liquid crystal layer. Accordingly, light incident upon the liquid crystal device of the VA mode from a front direction can be properly modulated when no voltage is applied to the liquid crystal layer (unapplied state), and therefore high contrast can be attained. On the other hand, although the liquid crystal device of the VA mode is capable of properly modulating light incident thereon from the front direction, the display characteristic with respect to light incident from an oblique direction is degraded, for example degradation in contrast and tone reversal, i.e., reversal of brightness of a medium tone, due to inclination of the liquid crystal molecules. Accordingly, a liquid crystal panel provided with a phase difference compensation element has been proposed.

For example, JP-A-2011-180487 discloses a liquid crystal panel including a first phase difference compensation element having a first optical axis and a second phase difference compensation element having a second optical axis, so that the alignment direction of the liquid crystal molecules is set, when projection is performed on an imaginary plane parallel to the liquid crystal panel, in an angular direction between a direction in which the first optical axis of the first phase difference compensation element extends, and a direction in which the second optical axis of the second phase difference compensation element extends.

In contrast, when the liquid crystal device is employed as light bulb of a projection display device, anti-dust translucent substrates are fixed on the respective surfaces of the liquid crystal panel to prevent foreign matters such as dust from directly sticking to the liquid crystal panel, to thereby prevent the foreign matters from being reflected in the projected image. Accordingly, as JP-A-2011-180487 teaches that “optical compensation unit may be given a dust-proof function. Integrating the optical compensation with the dust-proof function allows the number of parts of the liquid crystal device to be reduced, thereby enabling the liquid crystal device to be manufactured at a low cost”, integrally providing in advance the first phase difference compensation element and the second phase difference compensation element to the anti-dust translucent substrates enables reduction in cost of the liquid crystal device.

However, the projection display device includes a plurality of sheets of liquid crystal panels, which may include the liquid crystal panels in which the liquid crystal molecules are aligned in the first direction and the liquid crystal panels in which the liquid crystal molecules are aligned in the second direction. In this case, the second optical axis of the second phase difference compensation element has to be reversed according to the alignment direction of the liquid crystal molecules, and therefore, when the first phase difference compensation element and the second phase difference compensation element are integrally provided to the anti-dust translucent substrate, two types of translucent substrates have to be prepared, in which the directions of the second optical axes of the respective second phase difference compensation elements are opposite to each other, on the basis of the alignment direction of the liquid crystal molecules. Consequently, the cost reduction effect expected from integrally providing the first phase difference compensation element and the second phase difference compensation element to the anti-dust translucent substrate is minimized.

### SUMMARY

An advantage of some aspects of the present invention is to provide a liquid crystal device capable of setting the optical axis of a phase difference compensation element in a proper direction based on an alignment direction of liquid crystal molecules, despite the phase difference compensation element being integrally provided to an anti-dust translucent substrate fixed to the liquid crystal panel, and an electronic apparatus including such a liquid crystal device.

In an aspect, the present invention provides a liquid crystal device including a liquid crystal panel including a liquid crystal layer, a translucent substrate located so as to overlap the liquid crystal panel and including a first phase difference compensation element provided on a first surface of the translucent substrate, and a second phase difference compensation element located on a side of the translucent substrate opposite to the liquid crystal panel. The translucent substrate is placed such that, in a plan view in a direction perpendicular to a surface of the liquid crystal panel, a first optical axis being an optical axis of the first phase difference compensation element intersects an alignment direction of liquid crystal molecules in the liquid crystal layer. The second phase difference compensation element is placed such that, in a plan view in a direction perpendicular to the surface of the liquid crystal panel, a second optical axis being an optical axis of the second phase difference compensation element intersects the alignment direction. The alignment direction is set between a direction of the first optical axis and a direction of the second optical axis, in a plan view in a direction perpendicular to the surface of the liquid crystal panel.

In another aspect, the present invention provides a method of manufacturing a liquid crystal device including providing a first phase difference compensation element on a first surface of a translucent substrate, placing the translucent substrate so as to overlap a liquid crystal panel including a liquid crystal layer, and placing a second phase difference compensation element on a side of the translucent substrate opposite to the liquid crystal panel. The placing of the translucent substrate includes placing the translucent substrate such that, in a plan view in a direction perpendicular to a surface of the liquid crystal panel, a first optical axis being an optical axis of the first phase difference compensation element intersects an alignment direction of liquid crystal molecules in the liquid crystal layer. The placing of the second phase difference compensation element includes placing the second phase difference compensation element such that, in a plan view in a direction perpendicular to the surface of the liquid crystal panel, a second optical axis being an optical axis of the second phase difference compensation element intersects the alignment direction, the alignment direction being set between a direction of the first optical axis and a direction of the second optical axis, in a plan view in a direction perpendicular to the surface of the liquid crystal panel.

With the liquid crystal device configured as above, the translucent substrate serves to prevent foreign matters such as dust from directly sticking to the liquid crystal panel, thereby preventing the foreign matters from being reflected in a displayed image. In addition, since the first phase difference compensation element is formed integrally with the translucent substrate, the cost of the liquid crystal device can be reduced compared with the case where the first phase difference compensation element and the translucent substrate are separated from each other. Further, the second phase difference compensation element can be placed in an orientation that accords with the alignment direction of the liquid crystal molecules, because of being provided separately from the translucent substrate.

In an embodiment of the liquid crystal device, for example, the liquid crystal molecules may be aligned so as to have a pretilt. The second phase difference compensation element may be placed such that, when a direction in which the first optical axis is projected to an imaginary plane parallel to the liquid crystal panel and located on a side of the second phase difference compensation element opposite to the liquid crystal panel is defined as 6 o'clock, a direction in which the second optical axis is projected to the imaginary plane corresponds to 9 o'clock, and the liquid crystal molecules may be aligned such that a direction in which a tilting direction of the pretilt is projected to the imaginary plane corresponds to 01:30. In an embodiment, the manufacturing method of the liquid crystal device may further include aligning the liquid crystal molecules so as to have a pretilt. The placing of the second phase difference compensation element may include placing the second phase difference compensation element such that, when a direction in which the first optical axis is projected to an imaginary plane parallel to the liquid crystal panel and located on the side of the second phase difference compensation element opposite to the liquid crystal panel is defined as 6 o'clock, a direction in which the second optical axis is projected to the imaginary plane corresponds to 9 o'clock, and aligning the liquid crystal molecules such that a direction in which a tilting direction of the pretilt is projected to the imaginary plane corresponds to 01:30.

In another embodiment of the liquid crystal device, the liquid crystal molecules may be aligned so as to have a pretilt. The second phase difference compensation element may be placed such that, when a direction in which the first optical axis is projected to an imaginary plane parallel to the liquid crystal panel and located on the side of the second phase difference compensation element opposite to the liquid crystal panel is defined as 6 o'clock, a direction in which the second optical axis is projected to the imaginary plane corresponds to 3 o'clock, and the liquid crystal molecules may be aligned such that a direction in which a tilting direction of the pretilt is projected to the imaginary plane corresponds to 10:30. In another embodiment, the manufacturing method of the liquid crystal device may further include aligning the liquid crystal molecules so as to have a pretilt. The placing of the second phase difference compensation element may include placing the second phase difference compensation element such that, when a direction in which the first optical axis is projected to an imaginary plane parallel to the liquid crystal panel and located on the side of the second phase difference compensation element opposite to the liquid crystal panel is defined as 6 o'clock, a direction in which the second optical axis is projected to the imaginary plane corresponds to 3 o'clock, and aligning the liquid crystal molecules such that a direction in which a tilting direction of the pretilt is projected to the imaginary plane corresponds to 10:30.

In an embodiment of the liquid crystal device, the first phase difference compensation element may have a columnar structure extending along the direction of the first optical axis, and the second phase difference compensation element may have a columnar structure extending along the direction of the second optical axis. The mentioned configuration allows the quality of an image viewed from an oblique direction, in the liquid crystal device of the VA mode.

In an embodiment of the liquid crystal device, preferably, the first phase difference compensation element may have a smaller front phase difference than the second phase difference compensation element. The mentioned configuration allows, even when the translucent substrate integrally formed with the first phase difference compensation element is fixed to the liquid crystal panel at an irregular angle, an impact of angular fluctuation to be mitigated by slightly correcting the angle of the second phase difference compensation element.

In an embodiment of the liquid crystal device, the liquid crystal panel may include a rectangular display region, and the display region may be formed such that, when a direction in which the first optical axis is projected to an imaginary plane parallel to the liquid crystal panel and located on the side of the second phase difference compensation element opposite to the liquid crystal panel is defined as 6 o'clock, shorter sides are oriented in a direction between 0 o'clock and 6 o'clock, and longer sides are oriented in a direction between 3 o'clock and 9 o'clock.

In an embodiment of the liquid crystal device, the liquid crystal panel may include a pixel electrode provided on a surface of a first substrate on a side of the liquid crystal layer, and the translucent substrate may be located on the other surface of the first substrate opposite to the liquid crystal layer.

In an embodiment of the liquid crystal device, the liquid crystal panel may include a second substrate located on a side of the liquid crystal layer opposite to the first substrate, and the second substrate may include a lens overlapping the pixel electrode in a plan view. Such a configuration contributes to improving contrast.

In an embodiment of the manufacturing method of the liquid crystal device, preferably, the method may further include inspecting deviation of an extending direction of the first optical axis, and the placing of the second phase difference compensation element may include adjusting an angular position of the second phase difference compensation element on a basis of an inspection result obtained from the inspecting of the deviation.

The liquid crystal device according to the present invention is applicable to various electronic apparatuses such as a mobile phone, a mobile computer, and a projection display device. In particular, the projection display device includes a light source unit for supplying light to the liquid crystal device, and a projection optical system for projecting the light optically modulated by the liquid crystal device.

### BRIEF DESCRIPTION OF THE DRAWINGS

The invention will be described with reference to the accompanying drawings, wherein like numbers reference like elements.

FIG. 1 is a plan view showing a liquid crystal device according to an embodiment of the present invention.

FIG. 2 is a cross-sectional view of the liquid crystal device according to the embodiment of the present invention.

FIG. 3 is a schematic drawing for explaining liquid crystal molecules in the liquid crystal device according to the embodiment of the present invention.

FIG. 4 is a schematic drawing for explaining a phase difference compensation element in the liquid crystal device according to the embodiment of the present invention.

FIG. 5 is a schematic drawing for explaining placement of the phase difference compensation element with respect to a liquid crystal panel, in the liquid crystal device according to the embodiment of the present invention.

FIG. 6 is a schematic drawing for explaining a relationship between the alignment direction of the liquid crystal molecules and the optical axis of the phase difference compensation element in the liquid crystal panel, in the liquid crystal device according to the embodiment of the present invention.

FIG. 7 is a schematic drawing for explaining an angular deviation adjustment process of the phase difference compensation element, in the liquid crystal device according to the embodiment of the present invention.

FIG. 8 is a schematic drawing for explaining placement of a phase difference compensation element with respect to another liquid crystal panel, in the liquid crystal device according to the embodiment of the present invention.

FIG. 9 is a schematic drawing for explaining a relationship between the alignment direction of the liquid crystal molecules and the optical axis of the phase difference compensation element in another liquid crystal panel, in the liquid crystal device according to the embodiment of the present invention.

FIG. 10 is a cross-sectional view of a liquid crystal device according to another embodiment of the present invention.

FIG. 11 is a schematic diagram showing a configuration of a projection display device (electronic apparatus) including the liquid crystal device according to the present invention.

### DESCRIPTION OF EXEMPLARY EMBODIMENTS

Referring to the drawings, an embodiment of the present invention will be described hereunder. In the drawings referred to in the description given below, layers and components are illustrated in different scale reduction, to visibly exhibit the layers and the components on the drawing. In the description given below on layers formed on a first substrate 10 (element substrate), “upper layer side” or “surface side” refers to a side of the first substrate 10 opposite to a substrate 19 (on the side of a second substrate 20), and “lower layer side” refers to the other side of the first substrate 10 facing the substrate 19. In the description given below on layers formed on the second substrate 20 (counter substrate), “upper layer side” or “surface side” refers to a side of the second substrate 20 opposite to a substrate 29 (on the side of the first substrate 10), and “lower layer side” refers to the other side of the second substrate 20 facing the substrate 29. In addition, directions and orientations of an optical axis and so forth referred to in the description given below will represent the directions and orientations of the optical axis and so forth projected on an imaginary plane parallel to a liquid crystal panel 100p and located on a side of a second phase difference compensation element 40 opposite to the liquid crystal panel 100p, and viewed from the side of the liquid crystal panel 100p. Further, in the description given below on directions and orientations on the imaginary plane parallel to the liquid crystal panel 100p, a side of the liquid crystal panel 100p to which a flexible circuit board 105 is connected, when the liquid crystal panel 100p is viewed from the side of the second substrate 20, will be defined as 6 o'clock direction; the side of the liquid crystal panel 100p opposite to the flexible circuit board 105 will be defined as 0 o'clock direction; a right direction will be defined as 3 o'clock direction; and a left direction will be defined as 9 o'clock direction.

### Configuration of Liquid Crystal Device

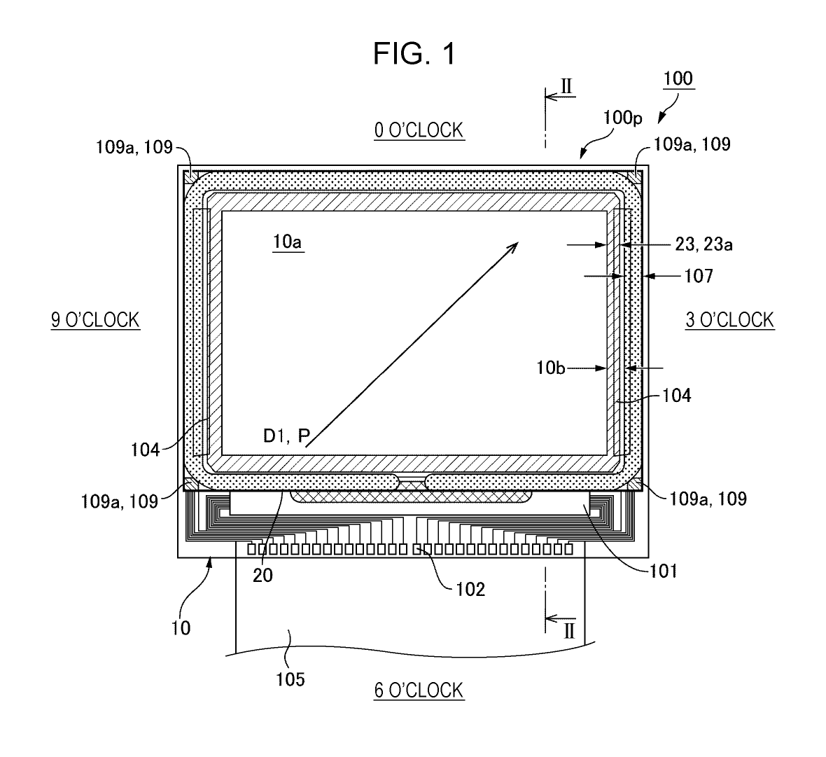

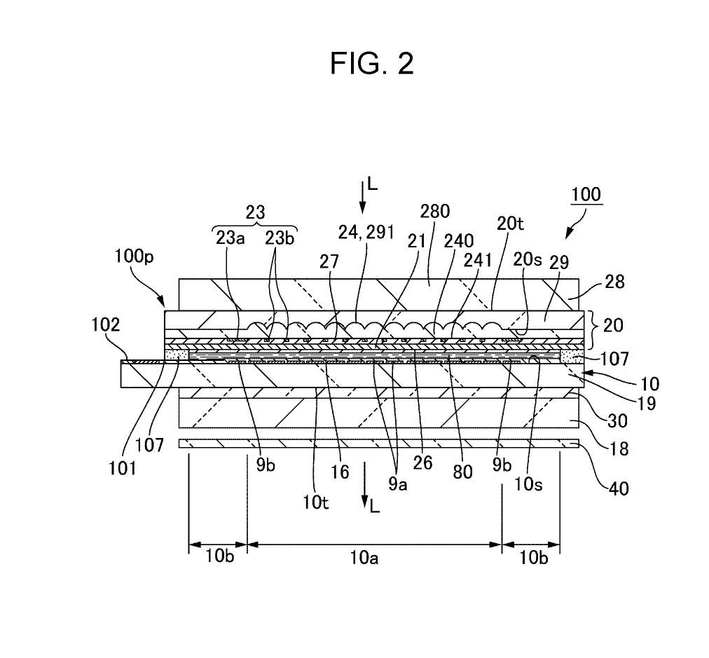

FIG. 1 is a plan view showing a liquid crystal device 100 according to the embodiment of the present invention. FIG. 2 is a cross-sectional view of the liquid crystal device 100 according to the embodiment of the present invention.

As shown in FIG. 1 and FIG. 2, the liquid crystal device 100 includes the liquid crystal panel 100p composed of the first substrate 10 (element substrate) and the second substrate 20 (counter substrate) bonded to each other via a sealing material 107 with a predetermined gap therebetween. In the liquid crystal panel 100p, the first substrate 10 and the second substrate 20 are opposed to each other. The sealing material 107 is provided in a frame shape along the outer edge of the second substrate 20, and a liquid crystal layer, provided in a region surrounded by the sealing material 107 between the first substrate 10 and the second substrate 20, constitutes a liquid crystal layer 80.

The first substrate 10 and the second substrate 20 are both rectangular, and a display region 10a is provided in a generally central region of the liquid crystal device 100, in a rectangular shape having longer sides oriented parallel to a direction between 3 o'clock and 9 o'clock and shorter sides oriented parallel to a direction between 0 o'clock and 6 o'clock direction. The sealing material 107 is also formed in a generally rectangular shape so as to follow up the shape of the display region 10a, and a peripheral region 10b of a rectangular frame shape is provided between the inner peripheral edge of the sealing material 107 and the outer peripheral edge of the display region 10a.

The base of the first substrate 10 is a translucent substrate 19 formed of quartz, glass, or the like. On a surface of the substrate 19 (first surface 10s) on the side of the second substrate 20, a data line driver circuit 101 and a plurality of terminals 102 are formed along a side of the first substrate 10 on an outer side of the display region 10a, and a scanning line driver circuit 104 is formed along another side adjacent to the mentioned side. A flexible circuit board 105 is connected to the terminals 102, so that potentials and signals are inputted to the first substrate 10 through the flexible circuit board 105.

A plurality of translucent pixel electrodes 9a each formed of an indium tin oxide (ITO) layer or the like, and non-illustrated pixel switching elements electrically connected to the respective pixel electrodes 9a, are formed in a matrix pattern in the display region 10a, on the side of the first surface 10s of the first substrate 10. A first alignment layer 16 is formed on the side of the second substrate 20 with respect to the pixel electrodes 9a, so as to cover the pixel electrodes 9a. In other words, the pixel electrodes 9a and the first alignment layer 16 are stacked in this order on the first substrate 10.

The base of the second substrate 20 is a translucent substrate 29 formed of quartz, glass, or the like. On the side of the surface of the substrate 29 facing the first substrate 10 (first surface 20s), a translucent common electrode 21 formed of the ITO layer is formed, and a second alignment layer 26 is formed on the side of the first substrate 10 with respect to the common electrode 21. In other words, the common electrode 21 and the second alignment layer 26 are stacked in this order on the second substrate 20. The common electrode 21 is formed generally all over the second substrate 20. A light shielding layer 23 formed of a metal or a metal compound, and a translucent cover layer 27 are provided on the opposite side of the first substrate 10 with respect to the common electrode 21. The light shielding layer 23 is, for example, formed as a frame-shaped end material 23a extending along the outer periphery of the display region 10a. The light shielding layer 23 is also formed as a light shielding layer 23b in a region overlapping a region between the adjacent pixel electrodes 9a in a plan view. In this embodiment, dummy pixel electrodes 9b simultaneously formed with the pixel electrodes 9a are provided in a region of the peripheral region 10b of the first substrate 10 overlapping the end material 23a in a plan view.

On the first substrate 10, an inter-substrate conducting electrode 109 for electrical connection between the first substrate 10 and the second substrate 20 are provided outside the sealing material 107, and in a region overlapping respective corner portions of the second substrate 20. The inter-substrate conducting electrode 19 includes an inter-substrate conducting material 109a containing conductive particles, and the common electrode 21 of the second substrate 20 is electrically connected to the side of the first substrate 10, via the inter-substrate conducting material 109a and the inter-substrate conducting electrode 109. Therefore, a common potential is applied to the common electrode 21 from the side of the first substrate 10.

In the liquid crystal device 100 according to this embodiment, the pixel electrodes 9a and the common electrode 21 are formed of a translucent conductive layer such as an ITO layer, and the liquid crystal device 100 is configured as a transmissive liquid crystal device. In the liquid crystal device 100 configured as above, light that has entered one of the first substrate 10 and the second substrate 20 is modulated while being transmitted through the other substrate and outputted therefrom, to thereby display an image. In this embodiment, the light that has entered the second substrate 20 is modulated by the liquid crystal layer 80 with respect to each pixel while being transmitted through the first substrate 10 and outputted therefrom as indicated by an arrow L in FIG. 2, to thereby display an image.

When the liquid crystal device 100 is employed as light bulb of a projection display device to be subsequently described, an anti-dust translucent substrate 18 is fixed on the other surface 10t of the first substrate 10 opposite to the second substrate 20, via an adhesive, as shown in FIG. 2. In addition, an anti-magnetic translucent substrate 28 is fixed to the other surface 20t of the second substrate 20 opposite to the first substrate 10, via an adhesive.

### Configuration of Lens 24 on Second Substrate 20

A light shielding layer including data lines and so on and pixel switching elements, which do not transmit light, are formed on the side of the first surface 10s of the first substrate 10. Accordingly, in the first substrate 10, for example regions overlapping the light shielding layer and the pixel switching elements in a plan view, and regions overlapping the region between the adjacent pixel electrodes 9a in a plan view, out of a region overlapping the pixel electrodes 9a in a plan view, form light-shielding regions that do not allow transmission of light. In contrast, regions not overlapping the light shielding layer and the pixel switching element in a plan view, out of the region overlapping the pixel electrodes 9a in a plan view, form open regions (translucent regions) that allow transmission of light. Therefore, only the light that has passed through the translucent region is involved in the display of an image, and the light directed to the light-shielding regions does not participate in displaying the image.

Now, a plurality of lenses 24 are provided on the second substrate 20 so as to respectively overlap the plurality of pixel electrodes 9a in a plan view, and the lenses 24 serve to convert the light that has entered the liquid crystal layer 80 into parallel light. This minimizes the inclination of the optical axis of the light entering the liquid crystal layer 80, thereby suppressing a phase shift in the liquid crystal layer 80 and preventing degradation in transmittance and contrast. In this embodiment, in particular, although the liquid crystal device 100 is configured as liquid crystal device of the VA mode, which may otherwise incur degradation in contrast depending on the inclination of the light entering the liquid crystal layer 80, the degradation in contrast can be effectively prevented with the configuration according to this embodiment.

Regarding the lenses 24, a plurality of lens surfaces 291, each formed in a concave shape, are formed on the first surface 20s of the substrate 29, so as to respectively correspond to the plurality of pixel electrodes 9a in a plan view. In addition, a translucent lens layer 240 is stacked on the first surface 20s of the substrate 29, and the surface 241 of the lens layer 240 opposite to the substrate 29 is flat. The substrate 29 and the lens layer 240 are different in refractive index from each other, and the lens surfaces 291 and the lens layer 240 constitute the lens 24. In this embodiment, the lens layer 240 has a larger refractive index than the substrate 29. For example, the substrate 29 is formed of a quartz substrate (silicon oxide, SiO₂) having a refractive index of 1.48, while the lens layer 240 is formed of a silicon oxynitride layer (SiON) having a refractive index of 1.58 to 1.68. Therefore, the lens 24 is capable of converging the light from the light source.

### Configuration of Liquid Crystal Layer 80

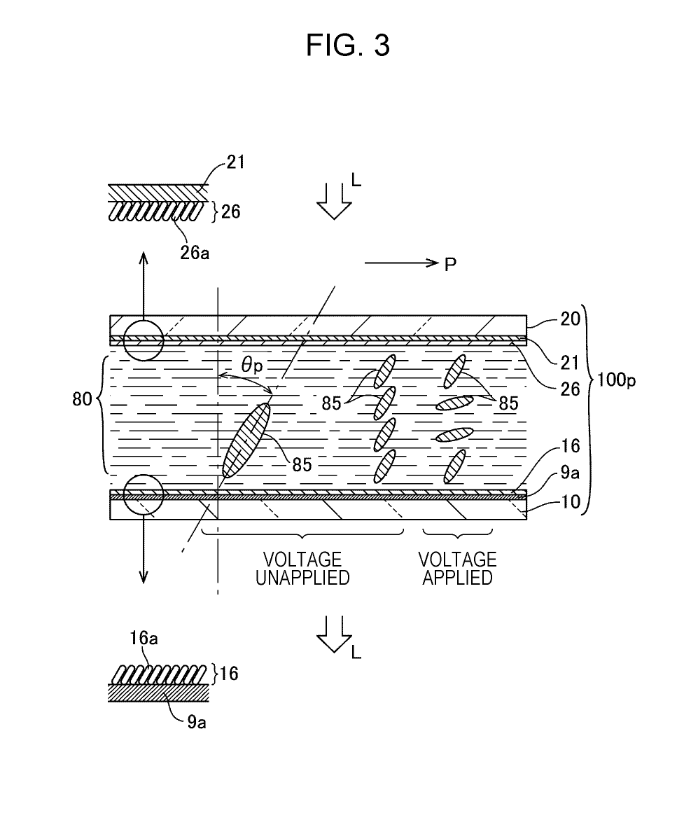

FIG. 3 is a schematic drawing for explaining liquid crystal molecules 85 in the liquid crystal device 100 according to the embodiment of the present invention. As shown in FIG. 3, the first alignment layer 16 and the second alignment layer 26 in the liquid crystal panel 100p are inorganic alignment layers (vertical alignment layer) formed of an obliquely deposited film of SiOₓ (x≦2), TiO₂, MgO, or Al₂O₃, and the first alignment layer 16 and the second alignment layer 26 each have a columnar structure including columns 16a or 26a formed with a tilt on the first substrate 10 or the second substrate 20. Thus, the first alignment layer 16 and the second alignment layer 26 serve to obliquely align the liquid crystal molecules 85, having negative dielectric constant anisotropy and employed in the liquid crystal layer 80, with respect to the first substrate 10 and the second substrate 20, to thereby apply a pretilt to the liquid crystal molecules 85. Here, a pretilt angle θp refers to an angle defined between a line orthogonal to the first substrate 10 and the second substrate 20 and an angle of the major axis (alignment direction) of the liquid crystal molecules 85, with no voltage being applied between the pixel electrodes 9a and the common electrode 21. Thus, the liquid crystal device 100 is configured as liquid crystal device of the VA (Vertical Alignment). In the liquid crystal device 100 thus configured, when a voltage is applied between the pixel electrodes 9a and the common electrode 21, the liquid crystal molecules 85 are displaced so as to reduce the tilt angle with respect to the first substrate 10 and the second substrate 20. The direction of such displacement corresponds to what is known as clear vision direction.

In this embodiment, as shown in FIG. 1, the alignment direction P (clear vision direction) of the liquid crystal molecules 85 can be expressed as first direction D1 extending from a position corresponding to 07:30 toward 01:30 on a clock, when projected on the imaginary plane parallel to the first substrate 10.

### Configuration of Phase Difference Compensation Element

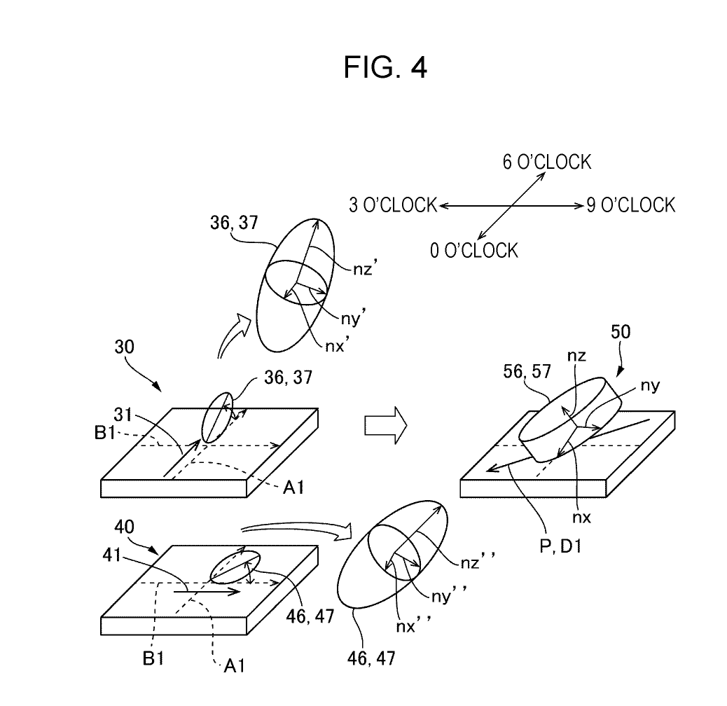

FIG. 4 is a schematic drawing for explaining a phase difference compensation element in the liquid crystal device 100 according to the embodiment of the present invention. In the liquid crystal device 100 according to this embodiment, as shown in FIG. 2 and FIG. 4, a first phase difference compensation element 30 having a first optical axis 31 that linearly extends when projected on the imaginary plane parallel to the liquid crystal panel 100p, and a second phase difference compensation element 40 having a second optical axis 41 that linearly extends when projected on the imaginary plane parallel to the liquid crystal panel 100p, are arranged on the liquid crystal panel 100p.

FIG. 4 illustrates the medium with anisotropic refractive index 36 of the first phase difference compensation element 30 in a form of a refractive index ellipse 37, in which a refractive index nz′ tilted from the direction of the normal of the imaginary plane is larger than refractive indices nx′, ny′ of other directions, the refractive index nx′ being larger than the refractive index ny′ (nz′>nx′>ny′). Likewise, FIG. 4 also illustrates the medium with anisotropic refractive index 46 of the second phase difference compensation element 40 in a form of a refractive index ellipse 47, in which a refractive index nz″ tilted from the direction of the normal of the imaginary plane is larger than refractive indices nx″, ny″ of other directions, the refractive index nx″ being larger than the refractive index ny″ (nz″>nx″>ny″).

Accordingly, when placing the first phase difference compensation element 30 and the second phase difference compensation element 40 on the liquid crystal panel 100p, making the first phase difference compensation element 30 oppose the second phase difference compensation element 40 such that the first optical axis 31 and the second optical axis 41 become orthogonal to each other allows the first phase difference compensation element 30 and the second phase difference compensation element 40 to act as phase difference compensation element 50, which is so-called a C plate. To be more detailed, the medium with anisotropic refractive index 36 of the first phase difference compensation element 30 and the medium with anisotropic refractive index 46 of the second phase difference compensation element 40 are synthesized in the phase difference compensation element 50, and therefore a medium with anisotropic refractive index 56 is generated in a form of a refractive index disk 57 having larger tilting angles, so as to have refractive indices nx, ny, nz (nz>nx=ny).

In this embodiment, for example, the first phase difference compensation element 30 is placed such that the first optical axis 31 (direction of refractive index nz′) is oriented in a direction A1 from 0 o'clock toward 6 o'clock, and the second phase difference compensation element 40 is placed such that the second optical axis 41 (direction of refractive index nz″) is oriented in a direction B1 from 3 o'clock toward 9 o'clock. As result, the first optical axis 31 and the second optical axis 41 are oriented so as to intersect the alignment direction P (clear vision direction) of the liquid crystal molecules 85, and the alignment direction P (clear vision direction) of the liquid crystal molecules 85 falls between the direction of the first optical axis 31 and the direction of the second optical axis 41. More specifically, the optical axis of the phase difference compensation element 50 (direction of refractive index nz) is oriented in the first direction D1 extending from 07:30 toward 01:30, which coincides with the alignment direction P (clear vision direction) of the liquid crystal molecules 85. Therefore, the phase difference of the liquid crystal panel 100p can be properly compensated.

Location of Phase Difference Compensation Element with Respect to Liquid Crystal Panel 100p

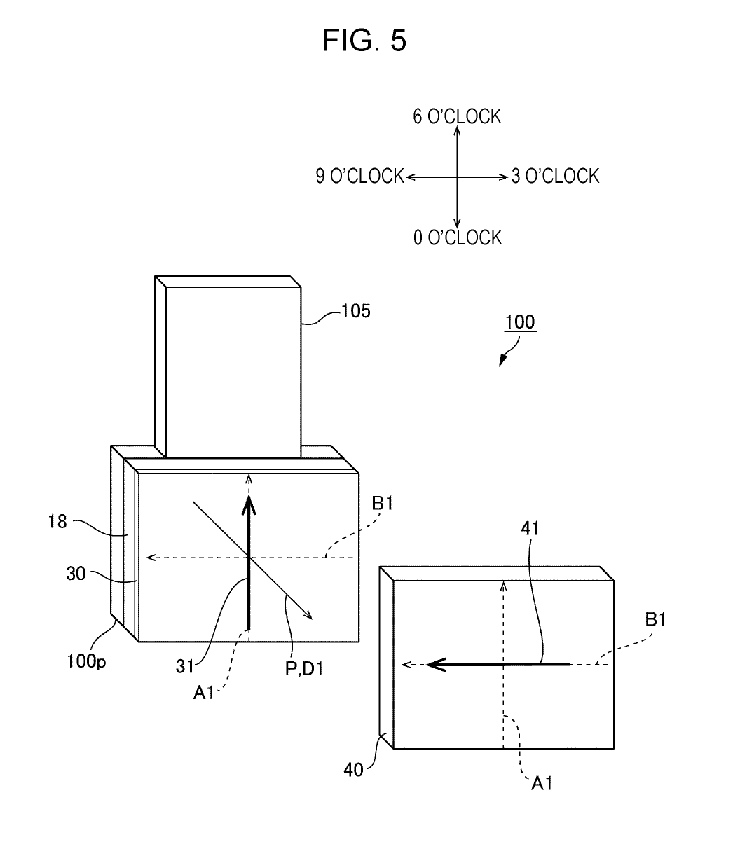

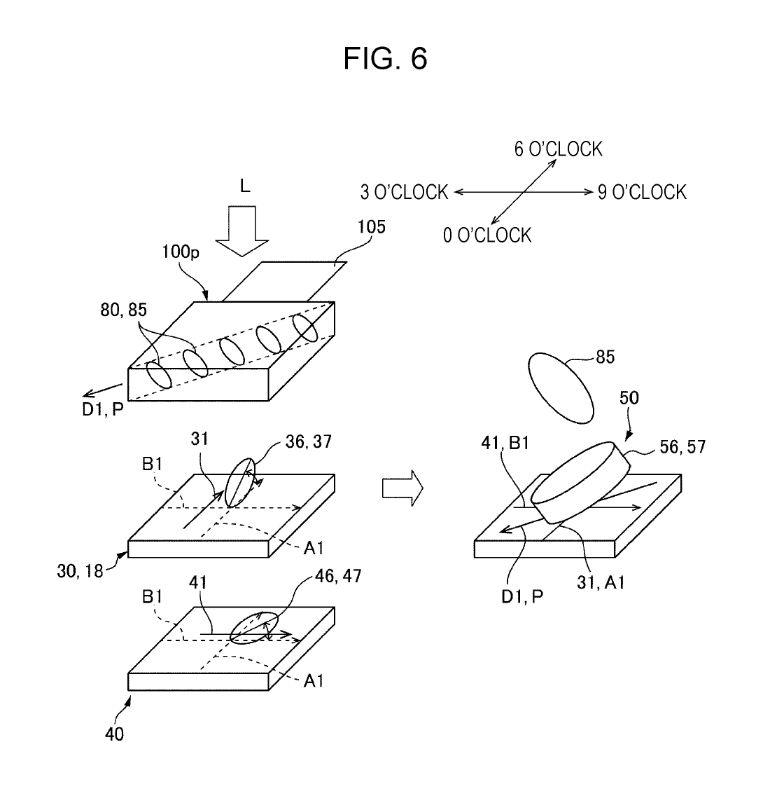

FIG. 5 is a schematic drawing for explaining the placement of the phase difference compensation element with respect to the liquid crystal panel 100p, in the liquid crystal device 100 according to the embodiment of the present invention. FIG. 6 is a schematic drawing for explaining a relationship between the alignment direction P of the liquid crystal molecules and the optical axis of the phase difference compensation element in the liquid crystal panel 100P, in the liquid crystal device 100 according to the embodiment of the present invention. Here, FIG. 1, FIG. 4, and FIG. 6 are the drawings viewed from the side of the second substrate 20, while FIG. 5 is the drawing viewed from the side of the first substrate 10. In FIG. 5, therefore, the direction between 3 o'clock and 9 o'clock is opposite to the direction in FIG. 1, FIG. 4, and FIG. 6.

In this embodiment, as shown in FIG. 5, the first phase difference compensation element 30 is integrally formed on the first surface of the anti-dust translucent substrate 18 fixed to the first substrate 10, when the first phase difference compensation element 30 and the second phase difference compensation element 40 are placed on the liquid crystal panel 100p. In this embodiment, the first phase difference compensation element 30 is formed on the surface of the translucent substrate 18 on the side of the liquid crystal panel 100p. The second phase difference compensation element 40 is, in contrast, separately formed from the translucent substrate 18 and opposed to the first phase difference compensation element 30. The first phase difference compensation element 30 has a columnar structure formed of a film obliquely deposited on the first surface of the anti-dust translucent substrate 18. In contrast, the second phase difference compensation element 40 has a columnar structure formed of a film obliquely deposited on the first surface of a non-illustrated translucent substrate.

Regarding the first phase difference compensation element 30, as shown in FIG. 6, the translucent substrate 18 is placed such that the first optical axis 31 is oriented in the direction A1 extending from 0 o'clock toward 6 o'clock when projected on the imaginary plane parallel to the liquid crystal panel 100p, according to the alignment direction P (first direction D1) of the liquid crystal molecules 85. Regarding the second phase difference compensation element 40, the second optical axis 41 is oriented in the direction B1 extending from 3 o'clock toward 9 o'clock when projected on the imaginary plane parallel to the liquid crystal panel 100p, according to the alignment direction P (first direction D1) of the liquid crystal molecules 85. Therefore, the alignment direction P (first direction D1, from 07:30 toward 01:30 on a clock) of the liquid crystal molecules 85 assumes an angular direction between the extending direction of the first optical axis 31 and the extending direction of the second optical axis 41. In other words, the optical axis of the phase difference compensation element 50 assumes an angular direction between the direction of the first optical axis 31 and the direction of the second optical axis 41, which coincides with the alignment direction P (first direction D1, from 07:30 toward 01:30 on a clock) of the liquid crystal molecules 85. Therefore, the phase difference of the liquid crystal panel 100p can be properly compensated.

### Manufacturing Method of Liquid Crystal Device 100

To manufacture the liquid crystal device 100 according to this embodiment, first, panel preparation is performed including preparing the first substrate 10 having the pixel electrodes 9a and the first alignment layer 16 stacked in this order on the side of the first surface 10s, the second substrate 20 having the common electrode 21 and the second alignment layer 26 stacked in this order on the side of the first surface 20s opposed to the first substrate 10, and the liquid crystal panel 100p interposed between the first substrate 10 and the second substrate 20 and including the liquid crystal layer 80. In the liquid crystal layer 80 of the liquid crystal panel 100p, the liquid crystal molecules 85 are aligned in the first direction D1 (direction from 07:30 toward 01:30 on a clock) when projected on the imaginary plane parallel to the first substrate 10.

To prepare the translucent substrate, oblique deposition is performed on a first surface of the translucent substrate 28, to thereby integrally form the first phase difference compensation element 30 (columnar structure) having the first optical axis 31, on the first surface of the translucent substrate 28.

Then, fixation of the translucent substrate is performed. The translucent substrate 18 is fixed to the surface of the first substrate 10 opposite to the second substrate 20 via an adhesive, such that the first optical axis 31 is oriented in the direction A1 (direction from 0 o'clock toward 6 o'clock) intersecting the first direction D1. In addition, the translucent substrate 28 is fixed to the surface of the second substrate 20 opposite to the first substrate 10, via an adhesive.

In a process of placing the second phase difference compensation element, the second phase difference compensation element 40 is placed so as to oppose the surface of the first phase difference compensation element 30 opposite to the liquid crystal panel 100p, such that second optical axis 41 is oriented in the direction B1 (direction from 3 o'clock toward 9 o'clock) orthogonal to the direction A1. As result, the liquid crystal device 100 can be obtained in which the first direction D1 (alignment direction P of the liquid crystal molecules 85, i.e., clear vision direction) is located in the angular direction between the direction A1 from 0 o'clock toward 6 o'clock and the direction B1 from 3 o'clock toward 9 o'clock.

### Angular Deviation Adjustment

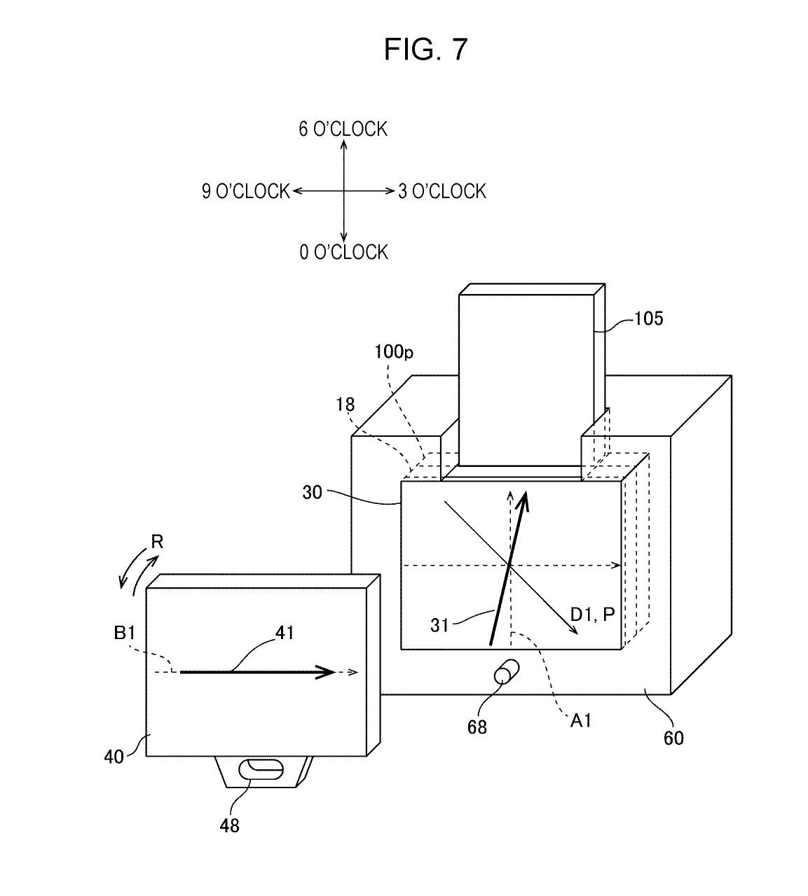

FIG. 7 is a schematic drawing for explaining an angular deviation adjustment process of the phase difference compensation element, in the liquid crystal device 100 according to the embodiment of the present invention.

In the manufacturing process of the liquid crystal device 100 according to this embodiment, an inspection process for inspecting a shift of the extending direction of the first optical axis 31 is performed after the fixing of the translucent substrate, and the angular position of the second phase difference compensation element 40 is adjusted in the placement of the second phase difference compensation element, according to the inspection result obtained through the inspection process. For example, when the first optical axis 31 of the first phase difference compensation element 30 proves to be deviated from the direction A1 from 0 o'clock toward 6 o'clock as result of the inspection process, the second phase difference compensation element 40 is made to rotate as indicated by arrows R in FIG. 7, so as to compensate the deviation of the first optical axis 31.

To adopt the mentioned adjustment method, the first phase difference compensation element 30 is given a smaller front phase difference than that of the second phase difference compensation element 40, in this embodiment. Accordingly, when the translucent substrate 18, integrally formed with the first phase difference compensation element 30, is fixed to the liquid crystal panel 100p, the impact of the angular deviation can be mitigated by slightly adjusting the angle of the second phase difference compensation element 40, even though the angular deviation takes place.

In the case, for example, where a protrusion 68 is provided on a holder 60 retaining the liquid crystal panel 100p, and an elongate hole 46 in which the protrusion 68 can be fitted is provided on the second phase difference compensation element 40, the impact of the angular deviation of the first phase difference compensation element 30 can be mitigated by adjusting the angle of the second phase difference compensation element 40 within an angular range that allows the protrusion 68 to remain fitted in the elongate hole 46.

### Remedy for Liquid Crystal Panel 100p Having Different Clear Vision Direction

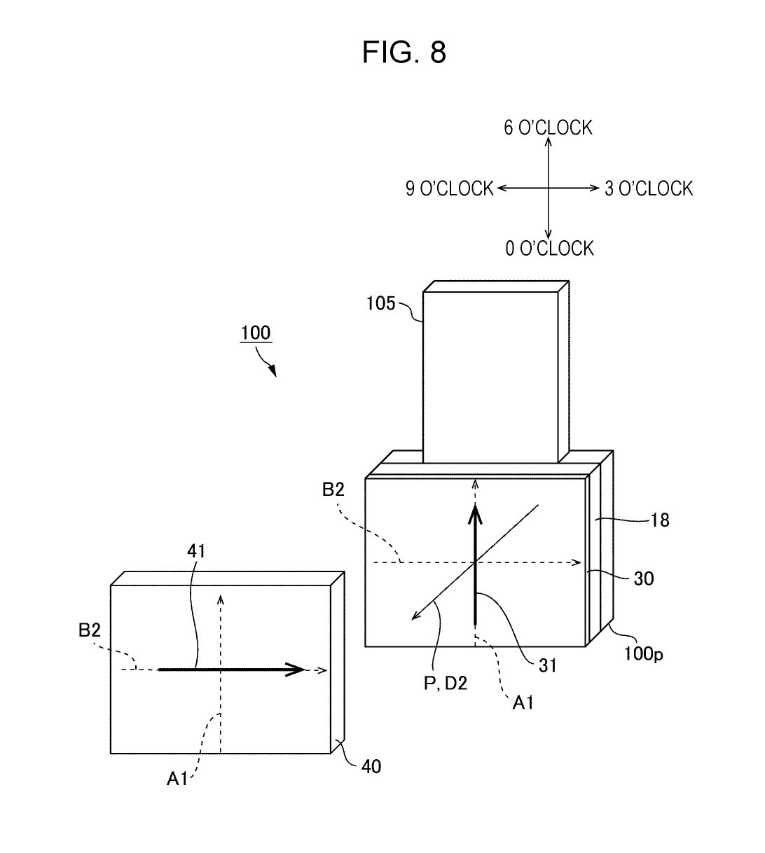

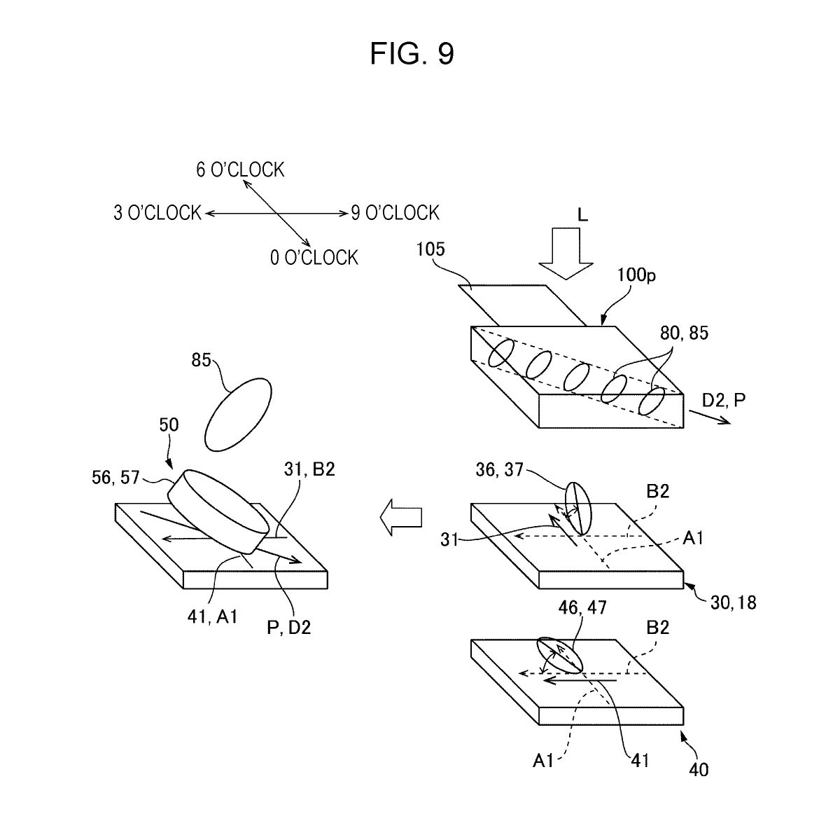

FIG. 8 is a schematic drawing for explaining placement of the phase difference compensation element with respect to another liquid crystal panel 100p, in the liquid crystal device 100 according to the embodiment of the present invention. FIG. 9 is a schematic drawing for explaining a relationship between the alignment direction P of the liquid crystal molecules and the optical axis of the phase difference compensation element in another liquid crystal panel 100p, in the liquid crystal device 100 according to the embodiment of the present invention. Here, FIG. 8 is a drawing viewed from the side of the second substrate 20, while FIG. 9 is a drawing viewed from the side of the first substrate 10. In FIG. 9, therefore, the direction between 3 o'clock and 9 o'clock is opposite to the direction in FIG. 8.

In the liquid crystal panel 100p described with reference to FIG. 5 and FIG. 6, the alignment direction of the liquid crystal molecules 85 is the first direction D1 when projected on the imaginary plane parallel to the liquid crystal panel 100p, however in the liquid crystal panel 100p shown in FIG. 8 and FIG. 9, the alignment direction of the liquid crystal molecules 85 is a second direction D2 from 04:30 toward 10:30 on a clock. In other words, the liquid crystal molecules 85 extend in the second direction D2 which is line-symmetrical to the first direction D1 about an imaginary line parallel to the first optical axis 31 in the liquid crystal layer 80, when projected on the imaginary plane parallel to the liquid crystal panel 100p.

In this case also, the first phase difference compensation element 30 is integrally formed with the first surface of the translucent substrate 18 fixed to the first substrate 10. In contrast, the second phase difference compensation element 40 is separately formed from the translucent substrate 18 and opposed to the first phase difference compensation element 30.

Now, in the first phase difference compensation element 30 the first optical axis 31 is oriented in the direction A1 from 0 o'clock toward 6 o'clock. In the second phase difference compensation element 40, in contrast, the second optical axis 41 is oriented in a direction B2 from 9 o'clock toward 3 o'clock, contrary to the embodiment described with reference to FIG. 5 and FIG. 6. Accordingly, the alignment direction P of the liquid crystal molecules 85 (clear vision direction) falls in an angular direction between the direction of the first optical axis 31 and the direction of the second optical axis 41, and therefore the phase difference of the liquid crystal panel 100p can be properly compensated.

To manufacture the liquid crystal device 100 configured as above, the preparation of the translucent substrate and the fixing of the translucent substrate may be carried out as described with reference to FIG. 5 and FIG. 6. Thereafter, in the placement of the second phase difference compensation element, the second phase difference compensation element 40 is placed such that the second optical axis 41 is oriented in the direction B2 from 9 o'clock toward 3 o'clock, and that the second direction D2 is located in the angular direction between the direction A1 of the first optical axis 31 and the direction B2 of the second optical axis 41. Therefore, the first phase difference compensation element 30 and the second phase difference compensation element 40 can both be placed such that the respective optical axes extend in proper directions on the basis of the alignment direction of the liquid crystal molecules 85, and consequently the phase difference can be properly compensated.

### ADVANTAGEOUS EFFECTS OF EMBODIMENT

As described thus far, the liquid crystal device 100 according to this embodiment includes the anti-dust translucent substrates 18, 28 fixed to the liquid crystal panel 100p, and therefore foreign matters such as dust can be prevented from directly sticking to the liquid crystal panel 100p. Accordingly, the foreign matters can also be prevented from being reflected in the image.

Out of the translucent substrates 18, 28, the translucent substrate 18 is integrally formed with the first phase difference compensation element 30, and therefore the cost of the liquid crystal device 100 can be reduced compared with the case where both of the first phase difference compensation element 30 and the second phase difference compensation element 40 are formed separately from the translucent substrate 18. In addition, since the second phase difference compensation element 40 is formed separately from the translucent substrate 18, the second phase difference compensation element 40 can be placed in the orientation that matches the alignment direction P of the liquid crystal molecules 85. In the manufacturing method of the liquid crystal device 100, for example, when the liquid crystal molecules 85 extend in the first direction D1 in the liquid crystal layer 80 when projected on the imaginary plane, in the placement of the second phase difference compensation element performed after the preparation of the translucent substrate and the fixing of the translucent substrate, the second phase difference compensation element 40 is placed such that the first direction D1 is located in an angular direction between the extending direction of the first optical axis 31 and the extending direction of the second optical axis. In contrast, when the liquid crystal molecules 85 extend in the second direction D2 line-symmetrical to the first direction D1 about an imaginary line parallel to the first optical axis 31 in the liquid crystal layer 80, in the placement of the second phase difference compensation element performed after the preparation of the translucent substrate and the fixing of the translucent substrate, the second phase difference compensation element 40 is placed such that the second direction D2 is located in an angular direction between the extending direction of the first optical axis 31 and the extending direction of the second optical axis. Therefore, the first phase difference compensation element 30 and the second phase difference compensation element 40 can both be placed such that the respective optical axes extend in proper directions on the basis of the alignment direction P of the liquid crystal molecules 85, and consequently the phase difference can be properly compensated.

In this embodiment, further, the second substrate 20 includes the lenses 24, and the translucent substrate 18, integrally formed with the first phase difference compensation element 30, is fixed to the first substrate 10. Such a configuration allows optical anisotropy of light condensed through the lens 24 and transmitted through the liquid crystal layer 80 to be compensated. Therefore, an advantage of higher contrast can be attained, compared with the case of integrally forming the first phase difference compensation element 30 with the translucent substrate 28 fixed to the second substrate 20.

### Additional Embodiment

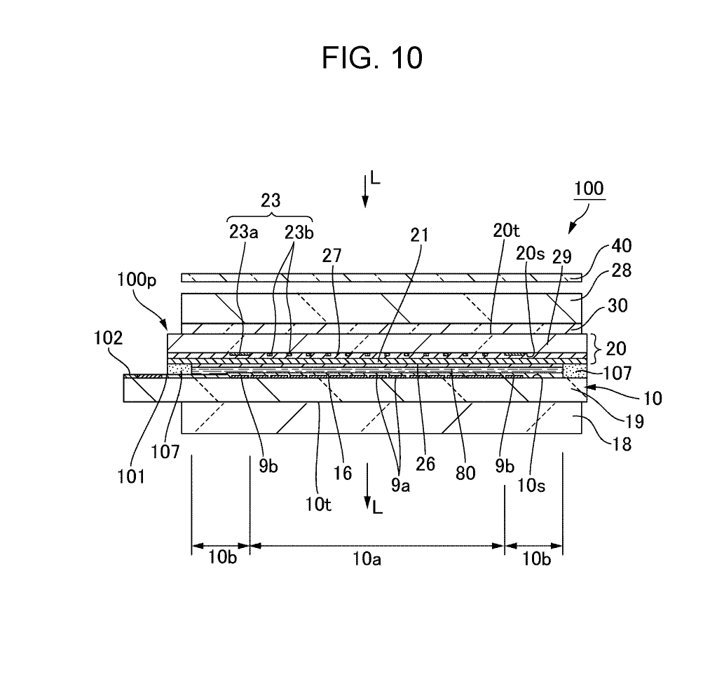

FIG. 10 is a cross-sectional view of the liquid crystal device 100 according to another embodiment of the present invention. Unlike the second substrate 20 in the foregoing embodiment, the second substrate 20 according to this embodiment does not include the lenses 24, as shown in FIG. 10. In this embodiment, accordingly, the first phase difference compensation element 30 is integrally formed on the surface of the translucent substrate 28 opposite to the first substrate 10, the translucent substrate 28 being fixed to the second substrate 20, and the second phase difference compensation element 40 is opposed to the first phase difference compensation element 30 on the opposite side of the liquid crystal panel 100p. In this embodiment, the first phase difference compensation element 30 is formed on the surface of the translucent substrate 28 on the side of the liquid crystal panel 100p.

With the mentioned configuration, the light enters the liquid crystal layer 80 after being subjected to compensation of the optical anisotropy, an advantage of higher contrast can be attained, compared with the case of integrally forming the first phase difference compensation element 30 with the surface of the translucent substrate 18 opposite to the second substrate 20, the translucent substrate 18 being fixed to the first substrate 10.

### Application Examples to Electronic Apparatus

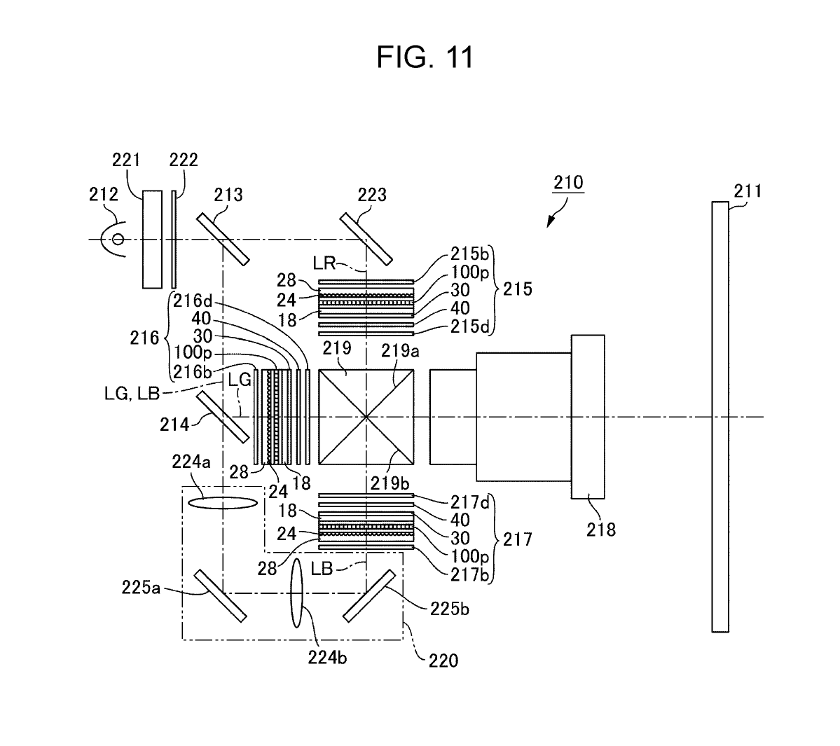

FIG. 11 is a schematic diagram showing a configuration of a projection display device (electronic apparatus) including the liquid crystal device 100 according to the present invention. The following description refers to a plurality of liquid crystal devices 100 (light bulb) that supply light of different wavelength regions from each other, all of which include the liquid crystal device 100 according to the present invention.

A projection display device 210 illustrated in FIG. 11 is a front projection-type projector that projects an image onto a screen 211 provided forward of the projection display device 210. The projection display device 210 includes a light source 212, dichroic mirrors 213, 214, liquid crystal light bulbs 215 to 217 each constituting the liquid crystal device according to the present invention, a projection optical system 218, a cross dichroic prism 219, and a relay system 220.

The light source 212 is constituted of an ultra-high pressure mercury lamp that emits light containing, for example, red light, green light, and blue light. The dichroic mirror 213 is configured to transmit the red light LR from the light source 212 but to reflect the green light LG and the blue light LB. The dichroic mirror 214 is configured to transmit the blue light LB and reflect the green light LG, out of the green light LG and the blue light LB reflected by the dichroic mirror 213. Thus, the dichroic mirrors 213, 214 constitute a color separation optical system that splits the light from the light source 212 into the red light LR, the green light LG, and the blue light LB. Between the dichroic mirror 213 and the light source 212, an integrator 221 and a polarization conversion element 222 are located in this order from the side of the light source 212. The integrator 221 serves to level off the illuminance distribution of the light emitted from the light source 212. The polarization conversion element 222 converts the light from the light source 212 into, for example, polarized light having a specific oscillation direction, such as s-polarized light.

The liquid crystal light bulb 215 is a transmissive liquid crystal device that modulates the red light LR which has been transmitted through the dichroic mirror 213 and reflected by the reflection mirror 223, according to the image signal. The liquid crystal light bulb 215 includes a first polarizing plate 215b, the anti-dust translucent substrate 28, the liquid crystal panel 100p, the anti-dust translucent substrate 18, the first phase difference compensation element 30, the second phase difference compensation element 40, and a second polarizing plate 215d. The red light LR which has entered the liquid crystal light bulb 215 is transmitted through the first polarizing plate 215b thus to be converted, for example, into s-polarized light. The liquid crystal panel 100p converts the received s-polarized light to p-polarized light through modulation according to the image signal (when the image is halftone, circular polarized light or elliptically polarized light). Further, the second polarizing plate 215d serves to block the s-polarized light and transmit the p-polarized light. Thus, the liquid crystal light bulb 215 modulates the red light LR according to the image signal and emits the modulated red light LR to the cross dichroic prism 219. In the case where the liquid crystal panel 100p includes the lenses 24 in this embodiment, the first phase difference compensation element 30 and the second phase difference compensation element 40 are located between the liquid crystal panel 100p and the second polarizing plate 215d.

The liquid crystal light bulb 216 is a transmissive liquid crystal device that modulates, according to the image signal, the green light LG which has been reflected by the dichroic mirror 213 and then reflected by the dichroic mirror 214, and emits the modulated green light LG to the cross dichroic prism 219. The liquid crystal light bulb 216 includes, like the liquid crystal light bulb 215, a first polarizing plate 216b, the anti-dust translucent substrate 28, the liquid crystal panel 100p, the anti-dust translucent substrate 18, the first phase difference compensation element 30, the second phase difference compensation element 40, and a second polarizing plate 216d. In the case where the liquid crystal panel 100p includes the lenses 24, the first phase difference compensation element 30 and the second phase difference compensation element 40 are located between the liquid crystal panel 100p and the second polarizing plate 216d.

The liquid crystal light bulb 217 is a transmissive liquid crystal device that modulates, according to the image signal, the blue light LB which has been reflected by the dichroic mirror 213, transmitted through the dichroic mirror 214, and has then passed through the relay system 220, and emits the modulated blue light LB to the cross dichroic prism 219. The liquid crystal light bulb 217 includes, like the liquid crystal light bulbs 215, 216, a first polarizing plate 217b, the anti-dust translucent substrate 28, the liquid crystal panel 100p, the anti-dust translucent substrate 18, the first phase difference compensation element 30, the second phase difference compensation element 40, and a second polarizing plate 217d. In the case where the liquid crystal panel 100p includes the lenses 24, the first phase difference compensation element 30 and the second phase difference compensation element 40 are located between the liquid crystal panel 100p and the second polarizing plate 217d.

The relay system 220 includes relay lenses 224a, 224b, and reflection mirrors 225a, 225b. The relay lenses 224a, 224b serve to prevent light loss of the blue light LB due to the lengthy optical path. The relay lens 224a is located between the dichroic mirror 214 and the reflection mirror 225a.

The relay lens 224b is located between the reflection mirrors 225a, 225b. The reflection mirror 225a is disposed so as to reflect the blue light LB which has been transmitted through the dichroic mirror 214 and outputted from the relay lens 224a, toward the relay lens 224b. The reflection mirror 225b is disposed so as to reflect the blue light LB which has been outputted from the relay lens 224b toward the liquid crystal light bulb 217.

The cross dichroic prism 219 is a color synthesis optical system including two dichroic films 219a, 219b disposed orthogonal to each other in an X-shape. The dichroic film 219a reflects the blue light LB and transmits the green light LG. The dichroic film 219b reflects the red light LR and transmits the green light LG.

Thus, the cross dichroic prism 219 is configured to synthesize the red light LR, the green light LG, and the blue light LB respectively modulated by the liquid crystal light bulbs 215 to 217, and to output the synthesized light to the projection optical system 218. The projection optical system 218 includes a non-illustrated projection lens, so as to project the light synthesized by the cross dichroic prism 219 onto the screen 211.

Here, the liquid crystal light bulbs (liquid crystal devices) 215, 217 for the red light and the blue right may each be provided with a λ/2 phase difference compensation element, to convert the light entering the cross dichroic prism 219 from the liquid crystal light bulbs 215, 217 into the s-polarized light, and the liquid crystal light bulb 216 may be set without the λ/2 phase difference compensation element so as to convert the light entering the cross dichroic prism 219 from the liquid crystal light bulb 216 into the p-polarized light.

Inputting the lights of different polarization states in the cross dichroic prism 219 allows constitution of a color synthesizing optical system optimized in consideration of the reflection characteristics of the dichroic films 219a, 219b. Normally the dichroic films 219a, 219b are excellent in reflection characteristic of the s-polarized light, and therefore it is preferable, as described above, to convert the red light LR and the blue light LB reflected by the dichroic films 219a, 219b into the s-polarized light, and convert the green light LG transmitted through the dichroic films 219a, 219b into the p-polarized light.

When the clear vision directions of the liquid crystal light bulbs 215, 216, and 217 are matched in the image projected by the projection display device 210 configured as above, the clear vision directions of the liquid crystal light bulbs 215, 217 and that of the liquid crystal light bulb 216 become opposite to each other. However, since all of the liquid crystal devices 100 that constitute the liquid crystal light bulb 215, 216, and 217 according to this embodiment include the anti-dust translucent substrate 18 with which the first phase difference compensation element 30 is integrally formed, the cost of the liquid crystal light bulbs 215, 216, and 217 can be reduced.

### Other Projection Display Devices

In the foregoing projection display device, for example LED light sources that respectively emit different colors may be employed to constitute a light source unit, and the color lights from the different LED light sources may be respectively supplied to different liquid crystal devices.

The liquid crystal device 100 according to the present invention may also be applied, for example, to a projection-type headup display (HUD) or a direct-view head mount display (HMD), in addition to the mentioned electronic apparatuses.

The entire disclosure of Japanese Patent Application No. 2015-197403, filed Oct. 5, 2015 is expressly incorporated by reference herein.

What is claimed is:

1. A liquid crystal device comprising:
a liquid crystal panel including a liquid crystal layer;
a translucent substrate located so as to overlap the liquid crystal panel;
a first phase difference compensation element provided between the translucent substrate and the liquid crystal panel; and
a second phase difference compensation element provided on a side of the translucent substrate opposite to the first phase difference compensation element,
wherein the first phase difference compensation element is placed such that, in a plan view in a direction perpendicular to the surface of the liquid crystal panel, a first optical axis being an optical axis of the first phase difference compensation element intersects an alignment direction of liquid crystal molecules in the liquid crystal layer,
the second phase difference compensation element is placed such that, in a plan view in a direction perpendicular to the surface of the liquid crystal panel, a second optical axis being an optical axis of the second phase difference compensation element intersects the alignment direction, and
the alignment direction is set between a direction of the first optical axis and a direction of the second optical axis, in a plan view in a direction perpendicular to the surface of the liquid crystal panel.

2. The liquid crystal device according to claim 1,
wherein the liquid crystal molecules are aligned so as to have a pretilt,
the second phase difference compensation element is placed such that, when a direction in which the first optical axis is projected to an imaginary plane parallel to the liquid crystal panel and located on a side of the second phase difference compensation element opposite to the liquid crystal panel is defined as 6 o'clock, a direction in which the second optical axis is projected to the imaginary plane corresponds to 9 o'clock, and
the liquid crystal molecules are aligned such that a direction in which a tilting direction of the pretilt is projected to the imaginary plane corresponds to 01:30.

3. The liquid crystal device according to claim 1,
wherein the liquid crystal molecules are aligned so as to have a pretilt,
the second phase difference compensation element is placed such that, when a direction in which the first optical axis is projected to an imaginary plane parallel to the liquid crystal panel and located on a side of the second phase difference compensation element opposite to the liquid crystal panel is defined as 6 o'clock, a direction in which the second optical axis is projected to the imaginary plane corresponds to 3 o'clock, and
the liquid crystal molecules are aligned such that a direction in which a tilting direction of the pretilt is projected to the imaginary plane corresponds to 10:30.

4. The liquid crystal device according to claim 1,
wherein the first phase difference compensation element has a columnar structure extending along the direction of the first optical axis, and
the second phase difference compensation element has a columnar structure extending along the direction of the second optical axis.

5. The liquid crystal device according to claim 1,
wherein the first phase difference compensation element has a smaller front phase difference than the second phase difference compensation element.

6. The liquid crystal device according to claim 1,
wherein the liquid crystal panel includes a rectangular display region, and
the display region is formed such that, when a direction in which the first optical axis is projected to an imaginary plane parallel to the liquid crystal panel and located on the side of the second phase difference compensation element opposite to the liquid crystal panel is defined as 6 o'clock, shorter sides are oriented in a direction between 0 o'clock and 6 o'clock, and longer sides are oriented in a direction between 3 o'clock and 9 o'clock.

7. The liquid crystal device according to claim 1,
wherein the liquid crystal panel includes a pixel electrode provided on a surface of a first substrate on a side of the liquid crystal layer, and
the translucent substrate is located on the other surface of the first substrate opposite to the liquid crystal layer.

8. The liquid crystal device according to claim 7,
wherein the liquid crystal panel includes a second substrate located on a side of the liquid crystal layer opposite to the first substrate, and
the second substrate includes a lens overlapping the pixel electrode in a plan view.

9. A method of manufacturing a liquid crystal device, the method comprising:
providing a first phase difference compensation element on a first surface of a translucent substrate;
placing the translucent substrate so as to overlap a liquid crystal panel including a liquid crystal layer; and
placing a second phase difference compensation element on a side of the translucent substrate opposite to the liquid crystal panel,
wherein the placing of the first phase difference compensation element includes placing the first phase difference compensation element such that, in a plan view in a direction perpendicular to the surface of the liquid crystal panel, a first optical axis being an optical axis of the first phase difference compensation element intersects an alignment direction of liquid crystal molecules in the liquid crystal layer, and
the placing of the second phase difference compensation element includes placing the second phase difference compensation element such that, in a plan view in a direction perpendicular to the surface of the liquid crystal panel, a second optical axis being an optical axis of the second phase difference compensation element intersects the alignment direction, the alignment direction being set between a direction of the first optical axis and a direction of the second optical axis, in a plan view in a direction perpendicular to the surface of the liquid crystal panel.

10. The method according to claim 9, further comprising aligning the liquid crystal molecules so as to have a pretilt,
wherein the placing of the second phase difference compensation element includes:
placing the second phase difference compensation element such that, when a direction in which the first optical axis is projected to an imaginary plane parallel to the liquid crystal panel and located on the side of the second phase difference compensation element opposite to the liquid crystal panel is defined as 6 o'clock, a direction in which the second optical axis is projected to the imaginary plane corresponds to 9 o'clock; and
aligning the liquid crystal molecules such that a direction in which a tilting direction of the pretilt is projected to the imaginary plane corresponds to 01:30.

11. The method according to claim 9, further comprising aligning the liquid crystal molecules so as to have a pretilt,
wherein the placing of the second phase difference compensation element includes:
placing the second phase difference compensation element such that, when a direction in which the first optical axis is projected to an imaginary plane parallel to the liquid crystal panel and located on the side of the second phase difference compensation element opposite to the liquid crystal panel is defined as 6 o'clock, a direction in which the second optical axis is projected to the imaginary plane corresponds to 3 o'clock; and
aligning the liquid crystal molecules such that a direction in which a tilting direction of the pretilt is projected to the imaginary plane corresponds to 10:30.

12. The method according to claim 9, further comprising inspecting deviation of an extending direction of the first optical axis,
wherein the placing of the second phase difference compensation element includes adjusting an angular position of the second phase difference compensation element on a basis of an inspection result obtained from the inspecting of the deviation.

13. An electronic apparatus comprising the liquid crystal device according to claim 1.

14. An electronic apparatus comprising the liquid crystal device according to claim 2.

15. An electronic apparatus comprising the liquid crystal device according to claim 3.

16. An electronic apparatus comprising the liquid crystal device according to claim 4.

17. An electronic apparatus comprising the liquid crystal device according to claim 5.

18. An electronic apparatus comprising the liquid crystal device according to claim 6.

19. An electronic apparatus comprising the liquid crystal device according to claim 7.

20. An electronic apparatus comprising the liquid crystal device according to claim 8.
